(19) United States
(12) Patent Application Publication
(10) Pub. No.: US 2025/0016104 A1
(43) Pub. Date: Jan. 9, 2025

(54) TRAFFIC IDENTIFIER SPREADING IN A MULTI-LINK DEVICE

(71) Applicant: MAXLINEAR, INC., Carlsbad, CA (US)

(72) Inventors: Arnon Meydav, Kfar-Saba (IL); Nimrod Kamieniecki, Hod-Hasharon (IL)

(73) Assignee: MAXLINEAR, INC., Carlsbad, CA (US)

(21) Appl. No.: 18/764,123

(22) Filed: Jul. 3, 2024

Related U.S. Application Data
(60) Provisional application No. 63/511,844, filed on Jul. 3, 2023.

(51) Int. Cl. H04L 47/125; H04L 47/2441; H04L 47/2483; H04W 28/08; H04W 84/12

(52) U.S. Cl. CPC H04L 47/125; H04L 47/2441; H04L 47/2483; H04W 28/0908; H04W 84/12

(57) ABSTRACT

A method includes obtaining an access category associated with network traffic. The network traffic includes one or more packets disposed in one or more sessions. The method also includes obtaining one or more traffic identifiers associated with the access category to assign to the one or more packets. The method further includes mapping the one or more traffic identifiers to one or more network links connecting a transmitting device and a receiving device. The method also includes assigning a first traffic identifier to first packets included in a first session of the one or more sessions and assigning a second traffic identifier to second packets included in a second session. The method further includes transmitting the first packets and the second packets to the receiving device using the one or more network links based on the mapping of the traffic identifiers to the network links.

### CROSS REFERENCE TO RELATED APPLICATIONS

This U.S. patent application claims priority to U.S. Provisional Patent Application No. 63/511,844, titled “TRAFFIC IDENTIFIER SPREADING VIA MULTI-LINK DEVICE,” and filed on Jul. 3, 2023, the disclosure of which is hereby incorporated by reference in its entirety.

### TECHNICAL FIELD

This disclosure relates to wireless communication, and more specifically, to traffic identifier spreading in a multi-link device.

### BACKGROUND

Unless otherwise indicated herein, the materials described herein are not prior art to the claims in the present application and are not admitted to be prior art by inclusion in this section.

Institute of Electrical and Electronics Engineers (IEEE) 802.11 standards include protocols for implementing wireless local area network (WLAN) communications, including Wi-Fi.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a method may include obtaining an access category associated with network traffic. The network traffic may include one or more packets disposed in one or more sessions and may be transmitted by a transmitting device to a receiving device. The method may also include obtaining one or more traffic identifiers that may be associated with the access category to assign to the one or more packets. The method may further include mapping the one or more traffic identifiers to one or more network links connecting the transmitting device and the receiving device. The method may also include assigning a first traffic identifier of the one or more traffic identifiers to first packets of the one or more packets that may be included a first session of the one or more sessions. The method may further include transmitting the first packets to the receiving device using the one or more network links based on the mapping of the one or more traffic identifiers to the one or more network links. The first packets may include the first traffic identifier. The method may also include assigning a second traffic identifier of the one or more traffic identifiers to second packets of the one or more packets that may be included in a second session of the one or more sessions. The method may further include transmitting the second packets to the receiving device using the one or more network links. The second packets may include in the second traffic identifier.

In another embodiment, a spreading device may include a first network link, a second network link and a processing device. The processing device may be operable to obtain an access category associated with network traffic. The network traffic may include one or more packets disposed in one or more sessions. The processing device may also be operable to obtain one or more traffic identifiers that may be associated with the access category to assign to the one or more packets. The processing device may further be operable to individually map the one or more traffic identifiers to at least the first network link and the second network link. The processing device may also be operable to assign a first traffic identifier of the one or more traffic identifiers to first packets of the one or more packets included a first session of the one or more sessions. The processing device may further be operable to transmit the first packets to a receiving device using the first network link based on the mapping of the one or more traffic identifiers to the first network link. The first packets may include the first traffic identifier. The processing device may also be operable to assign a second traffic identifier of the one or more traffic identifiers to second packets of the one or more packets included in a second session of the one or more sessions. The processing device may further be operable to transmit the second packets to the receiving device using the second network link based on the mapping of the one or more traffic identifiers to the second network link. The second packets may include the second traffic identifier.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for traffic identifier spreading;

FIG. 2 illustrates a block diagram of an example transmission and reception of network traffic using multiple network links;

FIG. 3 illustrates a block diagram of an example transmission and reception of network traffic using a single network link;

FIG. 4 illustrates a flowchart of an example method of performing an initialization operation associated with traffic identifier spreading;

FIG. 5 illustrates a flowchart of an example method of traffic identifier spreading operations;

FIG. 6 illustrates a flowchart of an example method of traffic identifier spreading in a multi-link device; and

FIG. 7 illustrates an example computing device.

### DETAILED DESCRIPTION

The Institute of Electrical and Electronics Engineers (IEEE) 802.11be (e.g., Wi-Fi 7) extension to the IEEE 802.11 standard facilitates wireless local area networks (LANs) supporting data transmissions (e.g., network traffic) using simultaneous multiple network links to a single receiving device, which may improve throughput, latency, and/or reliability of data transmissions in the LAN. Data transmissions using simultaneous multiple network links to a single receiving device is called multi-link operation (MLO), including simultaneous transmit-receive (STR) through a multi-link device (MLD).

In real-world network traffic scenarios (e.g., download of a web page containing embedded objects, download by file sharing protocols, simulated high-throughput traffic through a traffic generator, etc.), the network traffic may be received through multiple sessions. In some circumstances, the network traffic may arrive in a single Quality-of-Service (QOS), such as best effort network traffic, which is a defined access category in the IEEE 802.11 standard.

In accordance with the IEEE 802.11 standard, the network traffic may converted to a single wireless QoS traffic identifier. In instances in which a MLD traffic identifier-to-link mapping feature is utilized, the network traffic may be transmitted across multiple network links using a single traffic identifier. In the MLD, some resources for the same traffic identifier may be shared between some or all of the multiple network links. As a result of the shared resources, any delay and/or reduction of service on one network link of the multiple network links may cause a decrease in available resources associated with the traffic identifier on other network links of the multiple network links. In some circumstances, the decrease in available resources may cause a drop in throughput and/or a network traffic loss on some or all sessions that may be received by the receiving device. Alternatively, or additionally, increased latency may be experienced on some or all sessions that may be received by the receiving device. The drop in throughput and/or the increased latency may be captured and/or described by a block acknowledgement (block ack) scoreboard, which may be managed on a per traffic identifier basis, where the block ack scoreboard may be shared between the multiple network links when the same traffic identifier may be used thereon.

For example, in an existing approach, a block ack scoreboard may be used for a traffic identifier for all network links included in the MLD. As such, an issue or delay to first packets transmitted on a first network link (where a first traffic identifier may be assigned to the first packets) may limit the block ack scoreboard from advancing relative to packets transmitted on a second network link (where the first traffic identifier may be assigned to the second packets). In general, the block ack scoreboard may slide as packets are received/acknowledged and/or dropped. In such instances, if a first packet and a second packet are transmitted using a first network link and a set of packets (e.g., a third packet through a 256th packet) are transmitted using a second network link and due to interference on the first network link, the second packet is stuck in the first network link, the block ack scoreboard may be unable to proceed (e.g., slide) relative to the other received packets until the second packet is acknowledged or dropped. As such, in some instances, the aggregation capacity of the second network link may be dependent on the first network link as the first network link (which includes the first packet and the second packet) may need to complete transmission before the set of packets may be handled.

Alternatively, or additionally, the 802.11be extension defines new physical (PHY) layer rates for single network link communications, which may include extra high throughput (EHT). In some circumstances, the limits of aggregation size may be approached when the network traffic is received using a single traffic identifier. For example, when network traffic is transmitted using high throughput rates on a single network link (e.g., the rates defined as EHT in the 802.11be extension) and the network traffic is received using a single traffic identifier, a retransmission of one or more packets of the network traffic may cause the aggregation window size to bottleneck the data throughput. For example, the aggregation window may be limited to the lowest packet that was not successfully acknowledged, which may cause an effective aggregation size to be reduced. In such instances, the media access control (MAC) layer may become the bottleneck of achieving the maximum throughput allowed by the PHY layer.

For example, in an existing approach, in instances in which a first packet, a second packet, a third packet, and N additional packets are transmitted using a network link and a single traffic identifier, a first aggregation of the packets may be a maximum size (e.g., size N corresponding to the size of the session). In instances in which interference may be present in the network link, the first packet and the third packet may fail while the second packet and the N additional packets may succeed, such that the first packet and the third packet may be retransmitted. As such, in a second transmission, the aggregation associated with the session transmitted using the network link may be minimally utilized, as only the first packet and the third packet may be transmitted. Continuing the example, in instances in which the first packet succeeds and the third packets fails a second time, the block ack scoreboard associated with the traffic identifier assigned to the packets may slide to the third packet (as the first packet and the second packet have now successfully transmitted) which may support the transmission of two new packets (e.g., an N+1 packet and an N+2 packet) to follow the N additional packets-which may result in the a minimal utilization of the aggregation similar to previously described. Once the third packet is successfully transmitted (and acknowledged by the receiving device), the block ack scoreboard may slide to the N+3 new packet window (e.g., as the N+1 new packet and the N+2 new packets were previously transmitted during a minimal slide of the block ack scoreboard) and the aggregation of the packets may be a maximum size (e.g., size N).

The IEEE 802.11be extension defines MLO in a wireless network, and defines that one block ack scoreboard for each traffic identifier exists between all links participating in an MLD. The receiving MLD maintains a single reordering buffer for each traffic identifier, where the traffic identifier may be shared by all links of the receiving MLD. Further, the 802.11ax standard defines multi-traffic identifier in a wireless network, which may facilitate transmitting multiple traffic identifiers in the same aggregation. In some circumstances, transmitting multiple traffic identifiers may impose requirements on generated source traffic to be sent with different QoS configurations.

Prior approaches fail to address spreading network traffic among the links in an MLD to improve throughput, reduce network traffic losses, and/or decrease latency in an associated network. Alternatively, or additionally, prior approaches fail to mitigate negative effects experienced by one link on the behavior of the other links due to shared common resources between the links as part of MLO.

Aspects of the present disclosure address these and other limitations by assigning a traffic identifier to each session of network traffic to be transmitted as part of MLO. In the IEEE 802.11 wireless LAN standard, QoS is divided to four access categories and each access category contains multiple traffic identifiers that are mapped therein. As such, the network traffic transmitted from an MLD and corresponding to an access category may be spread using the multiple traffic identifiers associated with the corresponding access category. In such instances, the transmission of each session as part of MLO may be may be based on the quality of a single network link (e.g., and not the quality of other network links). Alternatively, or additionally, the spreading of the network traffic using the traffic identifiers in a single network link transmission operation may multiply available aggregation resources.

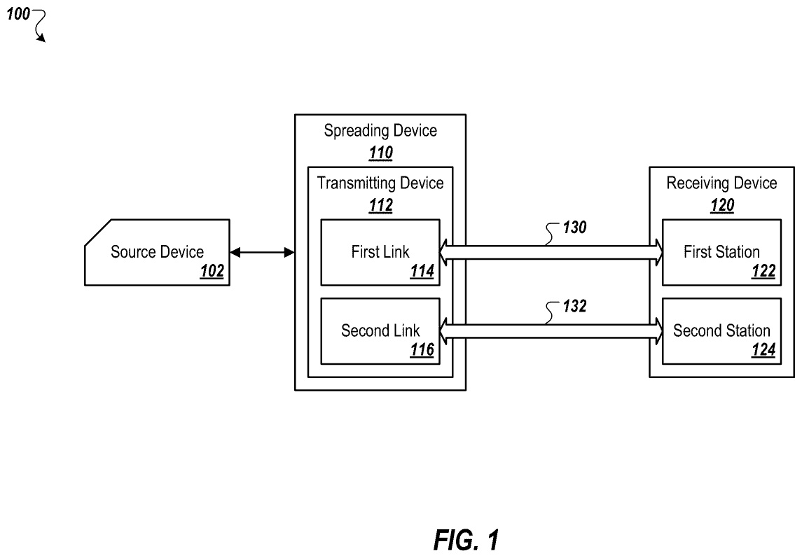

FIG. 1 illustrates a block diagram of an example system 100 for traffic identifier spreading, in accordance with at least one embodiment of the present disclosure. The system 100 may include a spreading device 110 and a receiving device 120. The spreading device 110 may include a transmitting device 112 and the transmitting device 112 may include a first link 114 and a second link 116. The receiving device 120 may include a first station 122 and a second station 124.

Network traffic may be generated by a source device 102 for transmittal to the receiving device 120 via the spreading device 110, as described herein. In some embodiments, the network traffic may include at least one or more packets disposed in one or more sessions that may be transmitted from the transmitting device 112 to the receiving device 120. The source device 102 may be any device or system that may produce or forward data and/or other network traffic to be transmitted to another device, such as the receiving device 120, via the spreading device 110. For example, the source device 102 may be a first device in a network and may generate data (e.g., network traffic) to be transmitted to the receiving device 120, and the source device 102 may communicate the network traffic to the spreading device 110 for transmission to the receiving device 120, as described herein.

The network traffic may be communicated to the spreading device 110 from the source device 102. The spreading device 110 may be a gateway, a router, an access point, and/or other device that may be operable to receive, transmit, and/or redirect the network traffic. In some embodiments, the first link 114 and/or the second link 116 may be operable to transmit the network traffic, such as network traffic transmitted to the receiving device 120. Alternatively, or additionally, the first station 122 and/or the second station 124 may be operable to receive the network traffic, such as network traffic transmitted from the transmitting device 112.

In some embodiments, the packets included in the network traffic may be separated into one or more sessions, where the packets in the one or more sessions may be transmitted from the transmitting device 112 to the receiving device 120 via a first network link 130 and/or a second network link 132. The first network link 130 and/or the second network link 132 may be operable to connect the transmitting device 112 and the receiving device 120 (e.g., the network traffic may be communicated between the transmitting device 112 to the receiving device 120 via the first network link 130 and/or the second network link 132). In some embodiments, the sessions may be associated with an access category that may correspond to a quality of service of the network traffic. For example, the quality of service may correspond to a video access category, a voice access category, a best effort access category, or a background access category. Alternatively, or additionally, the sessions may be associated with a traffic identifier that may be assigned to a particular access category. For example, a particular access category may include multiple traffic identifiers that may be assigned to the packets in a session. For example, a best effort access category may include traffic identifier 0 (e.g., TID0) and traffic identifier 3 (e.g., TID3). In some instances, a traffic identifier corresponding to an access category may

be assigned to each session. Alternatively, or additionally, an assignment of a traffic identifier to packets in a session may be limited to a single access category. For example, a first session that may be associated with the best effort access category (e.g., based on a quality of service associated with the network traffic) may include first packets that may be assigned a first traffic identifier (e.g., TID0), a second session that may be associated with the best effort access category may include second packets that may be assigned either the first traffic identifier or a second traffic identifier (e.g., TID3), and subsequent sessions that may be associated with the best effort access category may include third packets that may be assigned either the first traffic identifier or a second traffic identifier.

Alternatively, or additionally, traffic identifiers that may belong to more than one access category may be assigned to various sessions. For example, a first traffic identifier belonging to the best effort access category may be assigned to a first session that may be associated with the best effort access category, and a second traffic identifier belonging to the video access category may be assigned to a second session that may be associated with the video access category, and so forth. In these and other embodiments, a single traffic identifier may be assigned to each of the packets included in a session, such that each packet in a particular session may include an assigned traffic identifier that may be the same as the traffic identifier assigned to other packets in the particular session. As such, each session may include a traffic identifier uniformly assigned to the packets in the session.

In some instances, the transmitting device 112 may be a multi-link device that may be operable to communicate with one or more other devices using one or more network links. For example, the transmitting device 112 may be operable to transmit network traffic using a 2.4 GHz frequency band, a 5 GHz frequency band, and/or a 6 GHz frequency band, where any of the of bands may be used simultaneously. The transmitting device 112 may be operable to perform a mapping of the traffic identifiers to one or more network links associated with the transmitting device 112, such as the first network link 130 and/or the second network link 132. In some instances, the traffic identifier-to-network link mapping may conform to the IEEE 802.11be extension standard. For example, given a particular access category, each traffic identifier associated with the particular access category may be mapped to a unique link (e.g., the first network link 130 and/or the second network link 132) between the transmitting device 112 and the receiving device 120.

Alternatively, or additionally, in instances in which there are two links between the transmitting device 112 and the receiving device 120 (e.g., as illustrated in FIG. 1, with the first network link 130 and the second network link 132), the traffic identifiers associated with an access category may be individually mapped to one of the network links. For example, in instances in which the access category associated with the network traffic is best effort, a first traffic identifier (e.g., TID0) may be mapped to the first network link 130 and a second traffic identifier (e.g., TID3) may be mapped to the second network link 132.

In instances in which more than two network links are present between the transmitting device 112 and the receiving device 120, a calculation and/or an algorithm may be employed to determine a mapping of the traffic identifiers to the network links. For example, the algorithm may be a session-based weighted load balancing algorithm where packets included in the sessions may be transmitted without separation (e.g., packets included in a first session may not be separated and transmitted using multiple network links, rather all packets included in a session may be transmitted using one network link). Alternatively, or additionally, a weight associated with the load balancing algorithm may be determined for each session, where the weight may be used to determine a network link between the transmitting device 112 and the receiving device 120 which may be used to transmit the session.

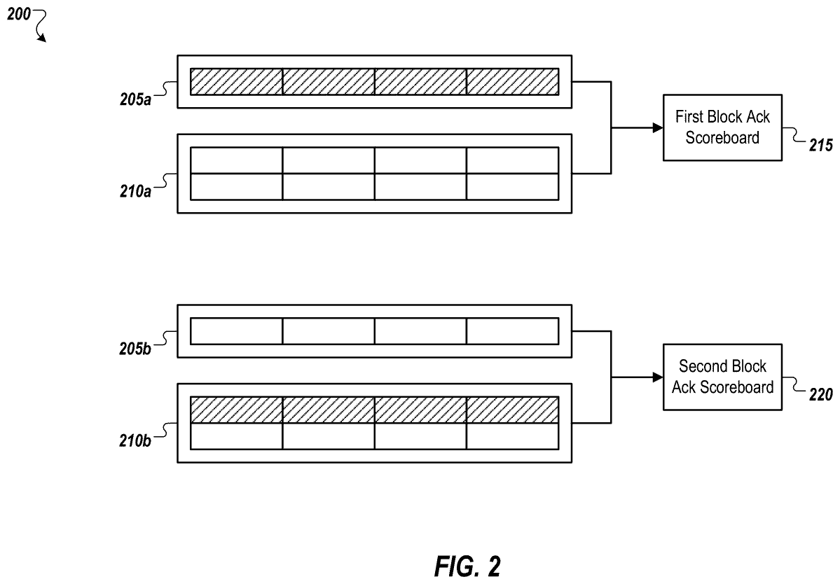

FIG. 2 illustrates a block diagram of an example diagram 200 including transmission and reception of network traffic using multiple network links, in accordance with at least one embodiment of the present disclosure. The diagram 200 may include a first traffic identifier first network link 205a, a second traffic identifier first network link 205b, collectively referred to as a first network link 205, a first traffic identifier second network link 210a, a second traffic identifier second network link 210b, collectively referred to as a second network link 210, a first block acknowledgement scoreboard 215 (also referred to as a first block ack scoreboard 215 or a first scoreboard 215), and a second block acknowledgement scoreboard 220 (also referred to as a second block ack scoreboard 220 or a second scoreboard 220).

The diagram 200 illustrates network traffic that may be transmitted from a transmitting device (such as the transmitting device 112 of FIG. 1) to a receiving device (such as the receiving device 120 of FIG. 1) via the first network link 205 and/or the second network link 210 (which may be the same or similar as the first network link 130 and/or the second network link 132 of FIG. 1). A first traffic identifier may be mapped to the first network link 205 and a second traffic identifier may be mapped to the second network link 210 such that a first session and a second session (illustrated as the shaded portions in the first network link 205 and the second network link 210, respectively) may be transmitted via the first network link 205 and the second network link 210, respectively.

The first network link 205 and the second network link 210 may be two different channels that may be utilized to transmit network traffic from the transmitting device to the receiving device. The first network link 205 and the second network link 210 may have different bandwidth available to support the transmissions as described herein, and correspondingly, may be illustrated as being different sizes in the diagram 200.

Alternatively, or additionally, the network traffic may be transmitted via the associated network links illustrated in the diagram 200 and the transmissions may be performed simultaneously.

For example, packets in a first session (and assigned a first traffic identifier) may be transmitted via the first network link 205 (or more particularly, via the first traffic identifier first network link 205a) and packets in a second session (and assigned a second traffic identifier) may be transmitted via the second network link 210 (or more particularly, via the second traffic identifier second network link 210b). In another example, packets in a first session (and assigned a first traffic identifier) may be transmitted via the second network link 210 (or more particularly, via the first traffic identifier second network link 210a) and packets in a second session (and assigned a second traffic identifier) may be transmitted via the first network link 205 (or more particularly, via the second traffic identifier first network link 205b). In both examples, the first scoreboard 215 may be operable to receive and process packets associated with the first traffic identifier and the second scoreboard 220 may be operable to receive and process packets associated with the second traffic identifier, regardless of the session, the channel, and/or the network link used to transmit the packets.

The first traffic identifier may be assigned to first packets included in the first session such that the first session may be transmitted via the first network link 205. Alternatively, or additionally the second traffic identifier may be assigned to second packets included in the second session such that the second session may be transmitted via the second network link 210. The number of packets that may be included in either the first session or the second session may be any number of packets, such as 128 packets, 256 packets, and/or any other number of packets, which may be defined by the 802.11 standard.

The first scoreboard 215 may be associated with the first traffic identifier and the second scoreboard 220 may be associated with the second traffic identifier. For example, the first scoreboard 215 may be operable to receive and/or monitor the first packets received by the receiving device, where the first packets include the first traffic identifier and the second scoreboard 220 may be operable to receive and/or track the second packets received by the receiving device, where the second packets include the second traffic identifier. The first scoreboard 215 and the second scoreboard 220 may be maintained without respect to the network link (e.g., the first network link 205 and/or the second network link 210) by which the packets of the sessions may be received. In an example, first packets having a first traffic identifier and included in a first session may be transmitted using the first network link 205 and second packets having the first traffic identifier and included in a second session may be transmitted using the second network link 210 and the first scoreboard 215 may receive and/or track the first session and the second session.

The first scoreboard 215 and/or the second scoreboard 220 may be sized according to the number of packets included in a session (as described herein) and may provide an indication of the packets received by the receiving device. For example, in instances in which the number of packets included in the first session is 256 packets, the first scoreboard 215 (associated with the first session via the traffic identifier) may be sized based on the 256 packets. As with the variation of the number of packets that may be included in a session, the size of the first scoreboard 215 and/or the second scoreboard 220 may be any size that may be accommodated by the receiving device. The size of the first scoreboard 215 and/or the second scoreboard 220 may align with a standard defined block ack window size and/or may be associated with a proprietary defined size that may differ from the standard define block ack window size.

In some instances, the first scoreboard 215 and/or the second scoreboard 220 may be operable to “slide” with a reception of packets received by the receiving device. For example, the first scoreboard 215 (and/or the second scoreboard 220) may receive the packets of a session and may slide through the packets, beginning with the first packet of the session, as the packets are received by the receiving device.

In instances in which one or more sessions transmitted from the transmitting device to the receiving device are assigned different traffic identifiers from one another, but still belong to the same access category (as described herein), an interference with packets in a first session having a first traffic identifier may not cause delays relative to the transmission of packets in a second session having a second traffic identifier. For example, a first traffic identifier may be assigned to a first session and the first session may be transmitted using the first network link 205, and a second traffic identifier may be assigned to a second session and the second session may be transmitted using the second network link 210. In such example, interference that may cause a delay in the reception of packets in the first session may not have any effect on the reception of packets in the second session.

For example, in instances in which interference causes a first packet of the first session (both the first packet and the first session assigned a first traffic identifier) to fail (e.g., fail to be received by the receiving device) via the first network link 205, the first scoreboard 215 associated with the first traffic identifier may be stuck at the first packet (e.g., unable to slide past the first packet to subsequent packets) until the first packet is acknowledged or dropped by the receiving device. Continuing the example, the interference and subsequent retransmission of the first packet may not cause changes to the performance of the transmission of second packets in the second session that may be assigned the second traffic identifier. In such instances, the second scoreboard 220 associated with the second traffic identifier may be operable to slide through the second packets in the second session as received by the receiving device via the second network link 210.

In some instances, a throughput of network traffic arranged in multiple sessions and transmitted via the first network link 205 and the second network link 210 may be comparable to splitting packets in a session and transmitting the split packets using the first network link 205 and the second network link 210. For example, in optimal conditions (e.g., limited to no interference in the network and/or in the network links), throughput of session-based transmissions (as described herein, e.g., where all packets included in a session are transmitted on one network link) may be the same or similar as a throughput associated with a transmission scheme that may separate packets of a session (e.g., packet-based transmissions) to be transmitted using both the first network link 205 and the second network link 210.

Alternatively, or additionally, in instances in which one of the first network link 205 and/or the second network link 210 is degraded and/or experiencing interference, the session-based transmissions may realize an improved performance relative to packet-based transmissions as an entire session may be transmitted via the first network link 205 or the second network link 210 (as opposed to a first subset of packets in a particular session transmitted on the first network link 205 and a second subset of packets in the particular session transmitted on the second network link 210). In such an arrangement, a degraded network link may not reduce the throughput of transmissions that may utilize other network links.

For example, interference in the first network link 205 may cause packets to be delayed that may be transmitted using the first network link 205 and in instances in which a session includes packets split between the first network link 205 and the second network link 210, a delay in the transmission of packets using the first network link 205 may cause delays and/or reduced throughput as the receiving device may experience reordering issues. The reordering issues may be attributed to packets included in a single session being received at different times by the receiving device. For example, a first subset of packets in a particular session may be received without delay (e.g., transmitted using the second network link 210 that may not have limited to no interference) and a second subset of packets may be received with a delay (e.g., transmitted using the first network link 205 that may experience interference) such that additional network traffic transmitted via the first network link 205 may be delayed as the delayed first subset of packets may be retransmitted and/or the receiving device may be delayed in reordering packets that may have been received.

In these and other embodiments, session-based transmissions, as described herein, may reduce or prevent reordering issues when the packets of a session are received by a receiving device. For example, when packets of a session are split and transmitted using both the first network link 205 and the second network link 210, some packets may be delayed due to interference associated with the first network link 205, which may cause delays and/or reordering issues at the receiving device, which, in turn, may affect the throughput of the network in which the packets are being transmitted.

Returning to FIG. 1, in instances in which there is one network link present (e.g., the first network link 130 is present and/or available for network traffic communications and the second network link 132 is not present and/or not available for network traffic communications) between the transmitting device 112 and the receiving device 120, the traffic identifiers associated with an access category may be mapped to each session to be transmitted between the transmitting device 112 and the receiving device 120 such that the ratio of traffic identifiers assigned to sessions (and correspondingly, assigned to the packets in the sessions) may be approximately 1:1. For example, in instances in which an even number of sessions are to be transmitted between the transmitting device 112 and the receiving device 120, a first traffic identifier may be assigned to a first half of the sessions and a second traffic identifier may be assigned to a second half of the sessions.

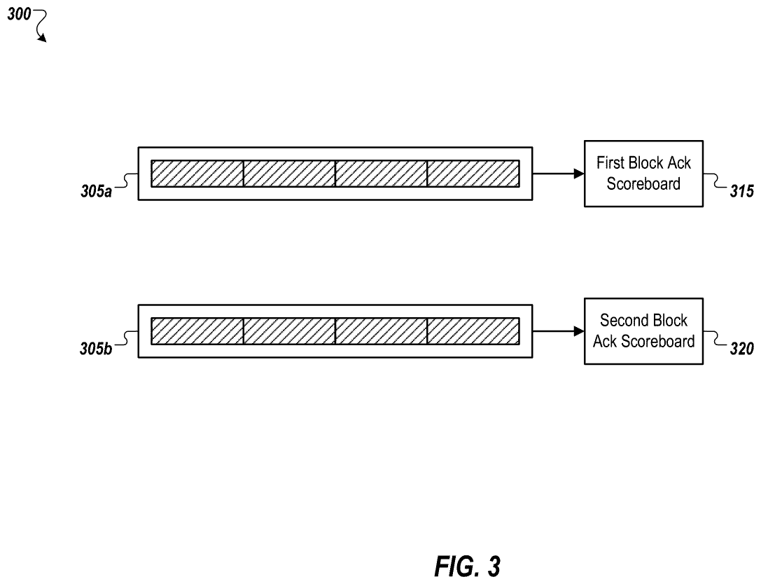

FIG. 3 illustrates a block diagram of an example diagram 300 including transmission and reception of network traffic using one network link, in accordance with at least one embodiment of the present disclosure. The diagram 300 may include a first traffic identifier network link 305a, a second traffic identifier network link 305b, collectively referred to as a network link 305, a first block acknowledgement scoreboard 315 (also referred to as a first block ack scoreboard 315 or a first scoreboard 315), and a second block acknowledgement scoreboard 320 (also referred to as a second block ack scoreboard 320 or a second scoreboard 320). The first traffic identifier network link 305a, the second traffic identifier network link 305b, the first scoreboard 315, and the second scoreboard 320 may be the same or similar as the first traffic identifier first network link 205a, the second traffic identifier first network link 205b, the first scoreboard 215, and the second scoreboard 220 of FIG. 2.

The first traffic identifier network link 305a and the second traffic identifier network link 305b may be individually operable to support different instances of network traffic being transmitted using the same network link (e.g., the network link 305). For example, at a first time, first packets in a first session may be transmitted via the network link 305 (e.g., the first traffic identifier network link 305a) and at a second time, second packets in a second session may be transmitted via the network link (e.g., the second traffic identifier network link 305b). In the example, the first packets may be received by the first scoreboard 315 and the second packets may be received by the second scoreboard 320, as described herein.

The diagram 300 illustrates network traffic that may be transmitted from a transmitting device (such as the transmitting device 112 of FIG. 1) to a receiving device (such as the receiving device 120 of FIG. 1) via the network link 305 (which may be the same or similar as the first network link 130 of FIG. 1). A first traffic identifier may be mapped to the network link 305 and a second traffic identifier may be mapped to the network link 305 such that a first session and a second session (illustrated as the shaded portions of the first traffic identifier network link 305a and the second traffic identifier network link 305b) may be transmitted via the network link 305, such as at different times. As described relative to FIG. 2, each session may include a particular number of packets that may vary in number and/or may be defined by the 802.11 standard.

The first scoreboard 315 may be associated with the first traffic identifier and the second scoreboard 320 may be associated with the second traffic identifier. Alternatively, or additionally, the first traffic identifier may be assigned to packets in a first session and the second traffic identifier may be assigned to packets in a second session.

In instances in which the first session and the second session are transmitted using the network link 305 (e.g., queued to be transmitted sequentially with the packets in the second session following the transmission of the packets in the first session), the first traffic identifier may be assigned to the first session and the second traffic identifier may be assigned to the second session. Using the first traffic identifier and the second traffic identifier with the first session and the second session, respectively, interference that may affect the transmission of packets in the first session may not ripple and adversely affect the transmission of packets in the second session. For example, in instances in which a first packet in the first session (and assigned the first traffic identifier) experiences interference (e.g., such that a retransmission of the first packet may be needed for reception by the receiving device), packets in the second session (assigned the second traffic identifier) may be transmitted and/or received without a hindrance caused by the interference and/or retransmission of the first packet in the first session.

Described another way, the first scoreboard 315 associated with the first traffic identifier (and by extension, the packets included in the first session) may be unable to slide beyond the first packet that experienced interference until the first packet is acknowledged (e.g., via a subsequent successful retransmission) or dropped. The reception of packets in the second session may be unhindered as the second scoreboard 320, associated with the second traffic identifier (and by extension, the packets included in the second session) may continue to slide without pause relative to the first packet of the first session as the second scoreboard 320 may be associated with the second traffic identifier. The second scoreboard 320 may indicate that any potential delay in the receiving queue of the receiving device (e.g., due to the first packet loss) may not cause a reordering issue relative to receiving the packets in the second session.

In these and other embodiments, interference associated with the first traffic identifier and/or packets in the first session may not cause a rippling interference and/or other perpetuated delays relative to transmission of packets in the second session that may be assigned to the second traffic identifier as the receiving device may be operable reorder the packets in the second session separate from the reordering the packets in the first session (e.g., due to the first scoreboard 315 and the second scoreboard 320), such that the aggregation of packets in the second session (and assigned the second traffic identifier) may continue. Alternatively, or additionally, interference associated with the second traffic identifier and/or packets in the second session may not cause a rippling interference and/or other perpetuated delays relative to transmission of packets in the first session that may be assigned to the first traffic identifier for substantially the same reasons.

Returning to FIG. 1, the mapping of the traffic identifiers to the first network link 130 and/or the second network link 132, and/or the assignment of the traffic identifiers to the sessions may be determined using an algorithm. The algorithm may be a session-based weighted load balancing algorithm where packets included in the sessions may be transmitted without separation (e.g., packets included in a first session may not be separated and transmitted using multiple network links, rather all packets included in a session may be transmitted using one network link). Alternatively, or additionally, a weight associated with the load balancing algorithm may be determined for each session, where the weight may be used to determine a network link between the transmitting device 112 and the receiving device 120 which may be used to transmit the session.

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

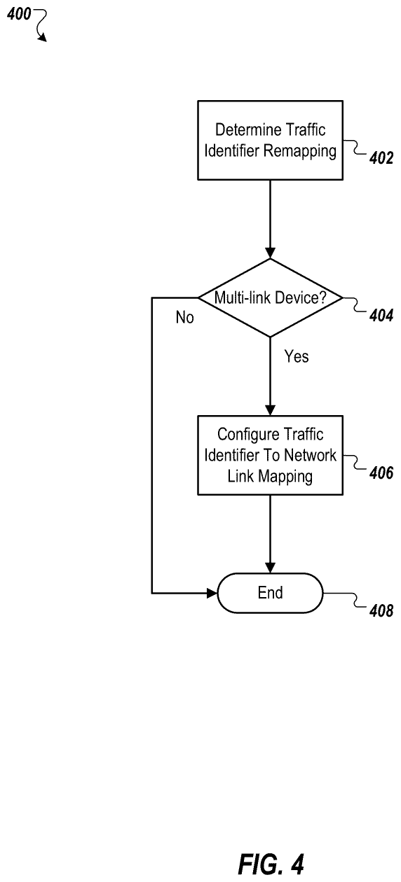

FIG. 4 illustrates a flowchart of an example method 400 of performing an initialization operation associated with traffic identifier spreading, in accordance with at least one embodiment of the present disclosure. The method 400, or subsequently described method 500 and/or method 600 may be performed by processing logic that may include hardware (circuitry, dedicated logic, etc.), software (such as is run on a general purpose computer system or a dedicated machine), or a combination of both, which processing logic may be included in any computer system or device such as the spreading device 110 or the transmitting device 112 of FIG. 1.

For simplicity of explanation, methods (e.g., the method 400, the method 500, and/or the method 600) described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 402, a determination may be made regarding whether one or more traffic identifiers may be remapped. For example, in instances in which a transmission is made using the best effort access category, TID0 and TID3 (e.g., traffic identifiers associated with the best effort access category) may be determined to be the traffic identifiers that may be remapped.

At block 404, a determination may be made as to whether a transmitting device operable to transmit network traffic, which may be assigned the traffic identifiers, is a multi-link device. In instances in which the transmitting device is not a multi-link device, the method 400 may proceed to block 408, which may be the end of the initialization operation. In such instances, the network traffic may be transmitted without any traffic identifier spreading, as described herein (e.g., a single traffic identifier associated with a particular access category may be assigned to each session associated with the particular access category and the session may be subsequently transmitted).

In instances in which the transmitting device is a multi-link device, the method 400 may proceed to block 406.

At block 406, a mapping of the traffic identifiers to network links included in a network may be determined. The network links and/or the network may be operable to facilitate multi-link operations. In some embodiments, the mapping of the traffic identifiers to the network links may vary based on the number of network links available in the network. For example, in instances in which there is one network link in the network, a session-based round robin approach may be used. In another example, in instances in which multiple links may be present in the network, a session-based weighted approach may be used. In these and other embodiments, one traffic identifier may be assigned to the packets corresponding to a particular session and/or the particular session. For example, the particular session may include a first set of packets and a second set of packets that may each be assigned the same traffic identifier, whereas some prior approaches may assign a first traffic identifier to the first set of packets and a second traffic identifier to the second set of packets.

Following the operations performed at block 406, the method 400 may proceed to block 408, which may be the end of the initialization operation.

In some embodiments, the traffic identifier spreading operations, as described herein, may be enabled or not enabled during initialization. For example, a first transmitting device may not enable traffic identifier spreading, and subsequently, may assign a particular traffic identifier to one or more sessions and/or corresponding session packets, and queue the sessions and/or the session packets for transmission. In another example, a second transmitting device may enable traffic identifier spreading and may assign a first traffic identifier to a first session and/or corresponding first session packets, and assign a second traffic identifier to a second session and/or corresponding second session packets, in accordance with an implemented sorting algorithm. In such instances, the second transmitting device may include traffic identifier spreading operations during initialization, as described herein.

Alternatively, or additionally, the traffic identifier spreading operations may be enabled or disabled in response to one or more changes associated with the network traffic, including various conditions associated with the transmitting device, the network, and/or the network links included in the network. For example, in response to a decrease of throughput in the network that satisfies a threshold amount, traffic identifier spreading operations (as described herein) may be implemented. In another example, in response to interference causing a threshold number of packets to fail to be obtained by a receiving device, traffic identifier spreading operations may be implemented. In these and other embodiments, the dynamic control of the traffic identifier spreading operations may be in response to changes in a data rate, a PHY rate, available bandwidth in the network and/or the network links, and/or other factors associated with the network, the network links, and/or the devices used therein (e.g., a transmitting device and/or a receiving device).

Modifications, additions, or omissions may be made to the method 400 without departing from the scope of the present disclosure. For example, the designations of different elements in the manner described is meant to help explain concepts described herein and is not limiting. Further, the method 400 may include any number of other elements or may be implemented within other systems or contexts than those described.

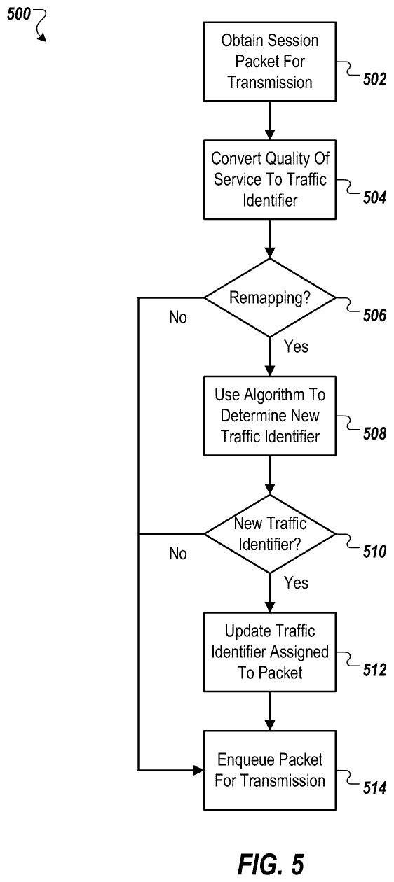

FIG. 5 illustrates a flowchart of an example method of traffic identifier spreading operations, in accordance with at least one embodiment of the present disclosure. At block 502, a session packet associated with a session may be obtained and/or queued for transmission within a network. The session packet may be transmitted by a transmitting device included in the network.

At block 504, the transmitting device may convert a quality of service associated with the session and/or the session packet traffic identifier (e.g., a Wi-Fi traffic identifier), where the traffic identifier may be associated with an access category that may be based on the quality of service.

At block 506, a determination as to whether the traffic identifier may be configured to be remapped may be performed. The configuration for remapping the traffic identifier may be performed during an initialization operation, such as described relative to the method 400 in FIG. 4. In instances in which the traffic identifier is not configured for remapping, no traffic identifier may be assigned to the session packet and the session packet may be queued for transmission by the transmitting device, as described relative to block 514. The traffic identifier may be determined to not be configured for remapping during initialization, the quality of service may direct the network to not remap the traffic identifier, and/or the access category may be determined to not facilitate remapped traffic identifiers (e.g., such as by network rules).

In some embodiments, it may be determined that a traffic identifier need not be remapped for a session packet based on an association with another session packet that may have already been transmitted and/or queued for transmission. For example, in instances in which a first traffic identifier was configured for mapping to a first session packet included in a first session, a second session packet included in the first session may not need to a determination for a traffic identifier as the first traffic identifier may be assigned to all session packets included in the first session (e.g., the first traffic identifier assigned to the first session packet and to the second session packet). For example, the session packets included in a session have the same traffic identifier assigned thereto, such that a session may not be separated on multiple network links during transmission.

At block 508, a traffic identifier selection algorithm may be applied to the session packet to determine a particular traffic identifier to be assigned to the session packet. The traffic identifier selection algorithm may include any various selection algorithm, such as a session-based round robin approach, a session-based weighted approach, and/or any other selection algorithm. In some embodiments, the selection algorithm may be determined in view of the available network links in the network.

At block 510, a determination as to whether the selected traffic identifier is a new traffic identifier may be performed. The determination may consider whether the selected traffic identifier is new relative to the session packet to which the selected traffic identifier may be assigned. In instances in which the selected traffic identifier is not new relative to the session packet, no new traffic identifier may be assigned to the session packet and the session packet may be queued for transmission by the transmitting device, as described relative to block 514. For example, in instances in which the selected traffic identifier to be assigned to a particular session packet is TID0 and the traffic identifier TID0 was already assigned to the particular session packet, the particular session packet may not be assigned a new traffic identifier and the particular session packet may be enqueued for transmission, as described relative to block 514.

At block 512, the traffic identifier as determined by the selection operation described in block 508, may be assigned to the session packet. Alternatively, or additionally, the packet frame associated with the session packet may be updated to include the traffic identifier that may have been assigned to the session packet.

At block 514, the session packet may be enqueued for transmission. In these and other embodiments, queuing the session packet for transmission may be based on the number of network links included in the network. For example, in instances in which the network includes a single network link, the session packet may be enqueued for transmission via the single network link. In instances in which the network includes more than one network link, the session packet may be enqueued to a network link based on the traffic identifier-to-link mapping that may be performed as part of initialization. For example, the traffic identifier-to-link mapping may determine that a particular traffic identifier be transmitted via a first network link, and when the particular traffic identifier is assigned to a particular packet and subsequently queued, the particular packet may be enqueued for transmission via the first network link.

Modifications, additions, or omissions may be made to the method 500 without departing from the scope of the present disclosure. For example, the designations of different elements in the manner described is meant to help explain concepts described herein and is not limiting. Further, the method 500 may include any number of other elements or may be implemented within other systems or contexts than those described.

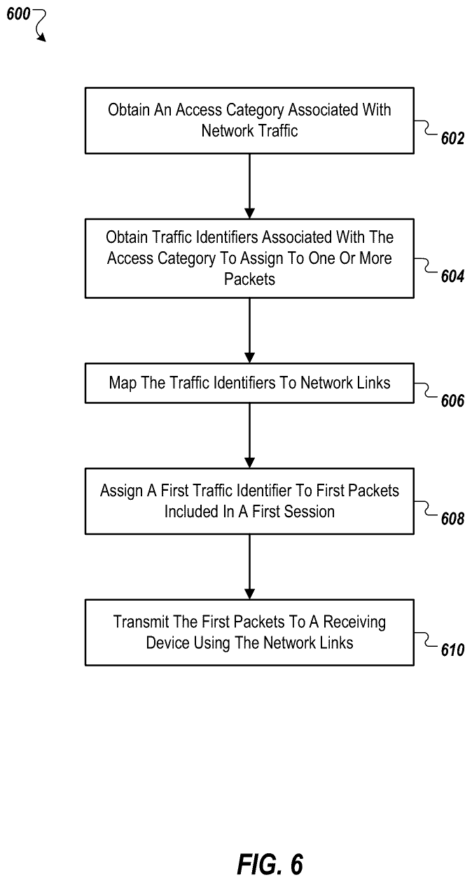

FIG. 6 illustrates a flowchart of an example method 600 of traffic identifier spreading in a multi-link device, in accordance with at least one embodiment of the present disclosure. At block 602, an access category associated with network traffic may be obtained. The network traffic may include one or more packets that may be disposed in one or more sessions. Alternatively, or additionally, the one or more packets may be transmitted by a transmitting device to a receiving device. In some instances, the access category may correspond to a quality of service associated with the network traffic.

At block 604, one or more traffic identifiers associated with the access category may be obtained. The one or more traffic identifiers may be assigned to the one or more packets.

At block 606, the one or more traffic identifiers may be mapped to one or more network links that may connect the transmitting device and the receiving device.

At block 608, a first traffic identifier of the one or more traffic identifiers may be assigned to first packets of the one or more packets that may be included a first session of the one or more sessions. In some instances, the first traffic identifier may be assigned to each packet of the first packets that may be included in the first session.

In some instances, the first traffic identifier may be mapped to a first network link of the one or more network links and a second traffic identifier of the one or more traffic identifiers may be mapped to a second network link of the one or more network links.

At block 610, the first packets may be transmitted to the receiving device using the one or more network links based on the mapping of the one or more traffic identifiers to the one or more network links. In some instances, the first packets may include the first traffic identifier.

In some instances, the first packets may be transmitted via the first network link and second packets of the one or more packets may be transmitted via the second network link based the first traffic identifier being mapped to the first network link and the second traffic identifier being mapped to the second network link. Alternatively, or additionally, the second traffic identifier may be assigned to the second packets.

Modifications, additions, or omissions may be made to the method 600 without departing from the scope of the present disclosure. For example, a second traffic identifier of the traffic identifiers may be assigned to second packets of the one or more packets that may be included a second session of the one or more sessions. Alternatively, or additionally, the second packets may be transmitted to the receiving device using the one or more network links, where the second packets may include the second traffic identifier.

In some instances, the first packets may be transmitted to the receiving device using a first network link of the one or more network links. Alternatively, or additionally, the second packets may be transmitted to the receiving device using a second network link of the one or more network links.

In another example, the designations of different elements in the manner described is meant to help explain concepts described herein and is not limiting. Further, the method 600 may include any number of other elements or may be implemented within other systems or contexts than those described.

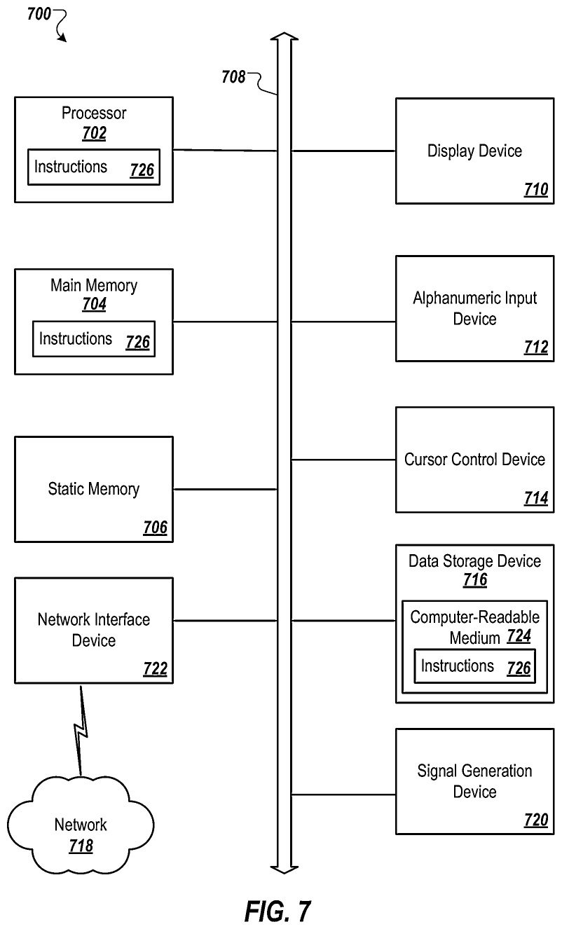

FIG. 7 illustrates an example computing device 700 within which a set of instructions, for causing the machine to perform any one or more of the methods discussed herein, may be executed. The computing device 700 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 700 includes a processing device 702 (e.g., a processor), a main memory 704 (e.g., read-only memory (ROM), flash memory, dynamic random access memory (DRAM) such as synchronous DRAM (SDRAM)), a static memory 706 (e.g., flash memory, static random access memory (SRAM)) and a data storage device 716, which communicate with each other via a bus 708.

The processing device 702 represents one or more general-purpose processing devices such as a microprocessor, central processing unit, or the like. More particularly, the processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also include one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein.

The computing device 700 may further include a network interface device 722 which may communicate with a network 718. The computing device 700 also may include a display device 710 (e.g., a liquid crystal display (LCD) or a cathode ray tube (CRT)), an alphanumeric input device 712 (e.g., a keyboard), a cursor control device 714 (e.g., a mouse) and a signal generation device 720 (e.g., a speaker). In at least one implementation, the display device 710, the alphanumeric input device 712, and the cursor control device 714 may be combined into a single component or device (e.g., an LCD touch screen).

The data storage device 716 may include a computer-readable storage medium 724 on which is stored one or more sets of instructions 726 embodying any one or more of the methods or functions described herein. The instructions 726 may also reside, completely or at least partially, within the main memory 704 and/or within the processing device 702 during execution thereof by the computing device 700, the main memory 704 and the processing device 702 also constituting computer-readable media. The instructions may further be transmitted or received over a network 718 via the network interface device 722.

While the computer-readable storage medium 724 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A method, comprising:
obtaining an access category associated with network traffic, the network traffic comprising one or more packets disposed in one or more sessions and to be transmitted by a transmitting device to a receiving device;
obtaining one or more traffic identifiers associated with the access category to assign to the one or more packets;
mapping the one or more traffic identifiers to one or more network links connecting the transmitting device and the receiving device;
assigning a first traffic identifier of the one or more traffic identifiers to first packets of the one or more packets included a first session of the one or more sessions;
transmitting the first packets to the receiving device using the one or more network links based on the mapping of the one or more traffic identifiers to the one or more network links, the first packets including the first traffic identifier;
assigning a second traffic identifier of the one or more traffic identifiers to second packets of the one or more packets included in a second session of the one or more sessions; and
transmitting the second packets to the receiving device using the one or more network links, the second packets including the second traffic identifier.

2. The method of claim 1, wherein the first packets are transmitted to the receiving device using a first network link of the one or more network links and the second packets are transmitted to the receiving device using a second network link of the one or more network links.

3. The method of claim 1, wherein the first traffic identifier is assigned to each packet of the first packets included in the first session.

4. The method of claim 1, wherein the first traffic identifier is mapped to a first network link of the one or more network links and a second traffic identifier of the one or more traffic identifiers is mapped to a second network link of the one or more network links.

5. The method of claim 4, wherein the first packets are transmitted via the first network link and second packets of the one or more packets are transmitted via the second network link based the first traffic identifier being mapped to the first network link and the second traffic identifier being mapped to the second network link, wherein the second traffic identifier is assigned to the second packets.

6. The method of claim 1, wherein the access category is a best effort access category.

7. The method of claim 1, wherein the mapping of the one or more traffic identifiers to the one or more network links is determined using an algorithm.

8. The method of claim 7, wherein the algorithm is a session-based weighted load balancing algorithm.

9. The method of claim 1, wherein a first scoreboard is to receive and process the first packets and a second scoreboard is to receive and process the second packets.

10. The method of claim 9, wherein the scoreboard is sized based on a number of the one or more packets disposed in the one or more sessions.

11. The method of claim 1, wherein the assignment of the first traffic identifier to the first packets and the second traffic identifier to the second packets is dynamically enabled in response to one or more changes associated with the network traffic.

12. A spreading device, comprising:
a first network link;
a second network link; and
a processing device operable to:
obtain an access category associated with network traffic, the network traffic comprising one or more packets disposed in one or more sessions;
obtain one or more traffic identifiers associated with the access category to assign to the one or more packets;
individually map the one or more traffic identifiers to at least the first network link and the second network link;
assign a first traffic identifier of the one or more traffic identifiers to first packets of the one or more packets included a first session of the one or more sessions;
transmit the first packets to a receiving device using the first network link based on the mapping of the one or more traffic identifiers to the first network link, the first packets including the first traffic identifier;
assign a second traffic identifier of the one or more traffic identifiers to second packets of the one or more packets included in a second session of the one or more sessions; and
transmit the second packets to the receiving device using the second network link based on the mapping of the one or more traffic identifiers to the second network link, the second packets including the second traffic identifier.

13. The spreading device of claim 12, wherein the first packets are transmitted to the receiving device using a first network link of the one or more network links and the second packets are transmitted to the receiving device using a second network link of the one or more network links.

14. The spreading device of claim 12, wherein the first packets are transmitted via the first network link and second packets of the one or more packets are transmitted via the second network link based the first traffic identifier being mapped to the first network link and the second traffic identifier being mapped to the second network link, wherein the second traffic identifier is assigned to the second packets.

15. The spreading device of claim 12, wherein the access category is a best effort access category.

16. The spreading device of claim 12, wherein the mapping of the one or more traffic identifiers to the one or more network links is determined using an algorithm.

17. The spreading device of claim 16, wherein the algorithm is a session-based round robin algorithm.

18. The spreading device of claim 12, wherein a first scoreboard is to receive and process the first packets and a second scoreboard is to receive and process the second packets.

19. The spreading device of claim 18, wherein the scoreboard is sized based on a number of the one or more packets disposed in the one or more sessions.

20. The spreading device of claim 12, wherein the assignment of the first traffic identifier to the first packets and the second traffic identifier to the second packets is dynamically enabled in response to one or more changes associated with the network traffic.

21. The spreading device of claim 12, wherein the first traffic identifier is mapped to a first network link of the one or more network links and a second traffic identifier of the one or more traffic identifiers is mapped to a second network link of the one or more network links.
